(19) United States
(12) Patent Application Publication
(10) Pub. No.: US 2025/0007582 A1
(43) Pub. Date: Jan. 2, 2025

(54) METHOD FOR REPORTING CHANNEL STATE INFORMATION IN WIRELESS COMMUNICATION SYSTEM AND APPARATUS THEREFOR

(71) Applicant: LG Electronics Inc., Seoul (KR)

(72) Inventors: Minseok JO, Seoul (KR); Sangrim LEE, Seoul (KR); Bonghoe KIM, Seoul (KR); Ikjoo JUNG, Seoul (KR); Hojae LEE, Seoul (KR)

(21) Appl. No.: 18/697,654

(22) PCT Filed: Oct. 1, 2021
(86) PCT No.: PCT/KR2021/013530

§ 371 Date: Apr. 1, 2024

(51) Int. Cl. H04B 7/06; H04L 5/00

(52) U.S. Cl. CPC H04B 7/0626; H04B 7/0639; H04L 5/0051

(57) ABSTRACT

The present disclosure provides a method for reporting, by a terminal, channel state information (CSI) in a wireless communication system. More specifically, the method includes: receiving, from a base station, a pilot signal related to calculation of a quantization rule, in which the quantization rule is determined based on an empirical distribution of an encoder neural network output of the terminal; transmitting, to the base station, quantization rule information related to the quantization rule calculated based on the pilot signal; and receiving, from the base station, information on a gradient calculated based on the quantization rule information, and the quantization rule information includes information on an empirically calculated variance with respect to the empirical distribution of the encoder neural network output.

### TECHNICAL FIELD

The present disclosure relates to a wireless communication system, and more particularly, to a method for reporting channel state information in a wireless communication system and an apparatus therefor.

### BACKGROUND ART

Wireless communication systems have been widely deployed to provide various types of communication services such as voice or data. In general, the wireless communication system is a multiple access system capable of supporting communication with multiple users by sharing available system resources (bandwidth, transmission power, etc.). Examples of multiple access systems include a Code Division Multiple Access (CDMA) system, a Frequency Division Multiple Access (FDMA) system, a Time Division Multiple Access (TDMA) system, a Space Division Multiple Access (SDMA) system, an Orthogonal Frequency Division Multiple Access (OFDMA) system, a Single Carrier Frequency Division Multiple Access (SC-FDMA) system, and an Interleave Division Multiple Access (IDMA) system.

### DISCLOSURE

### Technical Problem

The present disclosure provides a method for reporting channel state information in a wireless communication system and an apparatus therefor.

Furthermore, the present disclosure provides a method for optimizing a multiuser downlink precoding system and an apparatus therefor.

Furthermore, the present disclosure provides a method for transmitting quantization rule information according to a probability distribution of an output of a terminal encoder neural network to optimize a multiuser downlink precoding system and an apparatus therefor.

Furthermore, the present disclosure provides a method for constructing the quantization rule information according to a variance value of the probability distribution of the output of the terminal encoder neural network and an apparatus therefor.

Furthermore, the present disclosure provides a signaling method for optimizing a multiuser downlink precoding system and an apparatus therefor.

The technical objects of the present disclosure are not limited to the aforementioned technical objects, and other technical objects, which are not mentioned above, will be apparently appreciated by a person having ordinary skill in the art from the following description.

### Technical Solution

The present disclosure provides a method for reporting channel state information in a wireless communication system and an apparatus therefor.

More specifically, according to the present disclosure, a method for reporting, by a terminal, channel state information (CSI) in a wireless communication system includes: receiving, from a base station, a pilot signal related to calculation of a quantization rule, wherein the quantization rule is determined based on an empirical distribution of an encoder neural network output of the terminal; transmitting, to the base station, quantization rule information related to the quantization rule calculated based on the pilot signal; and receiving, from the base station, information on a gradient calculated based on the quantization rule information, and the quantization rule information includes information on an empirically calculated variance with respect to the empirical distribution of the encoder neural network output.

Furthermore, according to the present disclosure, the method further includes receiving, from the base station, information on a maximum information amount used for feedback of the quantization rule information related to the quantization rule.

Furthermore, according to the present disclosure, the method further includes transmitting, to the base station, (i) the number of neurons constituting an output layer of an encoder neural network of the terminal and (ii) information on an order pair of the number of bits used for quantization of the output of the encoder neural network of the terminal.

Furthermore, according to the present disclosure, the quantization rule information is calculated according to a period determined based on a batch size for training a neural network.

Furthermore, according to the present disclosure, the encoder neural network of the terminal includes (i) a quantization layer for quantization of an output value of the encoder neural network and (ii) a straight-through estimator (STE) function which is a differentiable function used during back-propagation.

Furthermore, according to the present disclosure, the information on the variance is transmitted based on a codebook configured by quantizing a range of a value of the variance.

Furthermore, according to the present disclosure, values which the output of the encoder neural network of the terminal may have follow a Gaussian distribution.

Furthermore, according to the present disclosure, when a mean value of the values which the output of the encoder neural network of the terminal may have is not 0, the quantization rule information further includes information on the mean value of the values which the output of the encoder neural network of the terminal may have.

Furthermore, according to the present disclosure, the transmitting of the quantization rule information further includes determining whether the empirical distribution of the output of the encoder neural network of the terminal is changed.

Furthermore, according to the present disclosure, when it is determined that the empirical distribution of the output of the encoder neural network of the terminal is changed, the information on the variance is transmitted.

Furthermore, according to the present disclosure, the method further includes receiving, from the base station, the information on the gradient calculated based on the quantization rule information.

Furthermore, according to the present disclosure, a pre-trained neural network parameter is updated based on the information on the gradient calculated based on the quantization rule information.

Furthermore, according to the present disclosure, when it is determined that the empirical distribution of the output of the encoder neural network of the terminal is not changed, the information on the variance is not transmitted, and the pre-trained neural network parameter is applied.

Furthermore, according to the present disclosure, the method further includes reporting, to the base station, the CSI calculated based on the pilot signal, and the CSI includes a precoding matrix indicator (PMI).

Furthermore, according to the present disclosure, the method further includes receiving downlink data from the base station, and the downlink data is transmitted based on precoding by a precoding matrix indicated by the PMI.

Furthermore, according to the present disclosure, a terminal for reporting channel state information (CSI) in a wireless communication system includes: a transmitter for transmitting a radio signal; a receiver for receiving the radio signal; at least one processor; and at least one computer memory operably connectable to the at least one processor, and storing instructions of performing operations when executed by the at least one processor, and the operations include receiving, from a base station, a pilot signal related to calculation of a quantization rule, wherein the quantization rule is determined based on an empirical distribution of an encoder neural network output of the terminal, transmitting, to the base station, quantization rule information related to the quantization rule calculated based on the pilot signal, and receiving, from the base station, information on a gradient calculated based on the quantization rule information, and the quantization rule information includes information on an empirically calculated variance with respect to the empirical distribution of the encoder neural network output.

Furthermore, according to the present disclosure, a method for being reported, by a base station, channel state information (CSI) in a wireless communication system includes: transmitting, to a terminal, a pilot signal related to calculation of a quantization rule, wherein the quantization rule is determined based on an empirical distribution of an encoder neural network output of the terminal, receiving, from the terminal, quantization rule information related to the quantization rule calculated based on the pilot signal; and transmitting, to the terminal, information on a gradient calculated based on the quantization rule information, and the quantization rule information includes information on an empirically calculated variance with respect to the empirical distribution of the encoder neural network output.

Furthermore, according to the present disclosure, a base station for being reported channel state information (CSI) in a wireless communication system includes: a transmitter for transmitting a radio signal; a receiver for receiving the radio signal; at least one processor; and at least one computer memory operably connectable to the at least one processor, and storing instructions of performing operations when executed by the at least one processor, and the operations include transmitting, to a terminal, a pilot signal related to calculation of a quantization rule, wherein the quantization rule is determined based on an empirical distribution of an encoder neural network output of the terminal, receiving, from the terminal, quantization rule information related to the quantization rule calculated based on the pilot signal, and transmitting, to the terminal, information on a gradient calculated based on the quantization rule information, and the quantization rule information includes information on an empirically calculated variance with respect to the empirical distribution of the encoder neural network output.

Furthermore, according to the present disclosure, in a non-transitory computer readable medium (CRM) storing one or more instructions, the one or more instructions allow a terminal to receive, from a base station, a pilot signal related to calculation of a quantization rule, wherein the quantization rule is determined based on an empirical distribution of an encoder neural network output of the terminal; transmit, to the base station, quantization rule information related to the quantization rule calculated based on the pilot signal; and receive, from the base station, information on a gradient calculated based on the quantization rule information, and the quantization rule information includes information on an empirically calculated variance with respect to the empirical distribution of the encoder neural network output.

Furthermore, according to the present disclosure, an apparatus includes: one or more memories, and one or more processors functionally connected to the one or more memories, and the one or more processors allow the apparatus to receive, from a base station, a pilot signal related to calculation of a quantization rule, wherein the quantization rule is determined based on an empirical distribution of an encoder neural network output of the terminal, transmit, to the base station, quantization rule information related to the quantization rule calculated based on the pilot signal, and receive, from the base station, information on a gradient calculated based on the quantization rule information, and the quantization rule information includes information on an empirically calculated variance with respect to the empirical distribution of the encoder neural network output.

### Advantageous Effects

According to the present disclosure, there is an effect in that channel state information can be reported in a wireless communication system.

Furthermore, according to the present disclosure, there is an effect in that a multiuser downlink precoding system can be optimized.

Furthermore, according to the present disclosure, there is an effect in that quantization rule information according to a probability distribution of an output of a terminal encoder neural network can be transmitted to optimize a multiuser downlink precoding system.

Furthermore, according to the present disclosure, there is an effect in that by constructing the quantization rule information according to a variance value of the probability distribution of the output of the terminal encoder neural network, signaling overhead for optimizing the multiuser downlink precoding system is reduced.

Furthermore, according to the present disclosure, there is an effect in that by constructing the quantization rule information according to a variance value of the probability distribution of the output of the terminal encoder neural network, efficiency of the quantization rule information for optimizing the multiuser downlink precoding system is increased.

Advantages which can be obtained in the present disclosure are not limited to the aforementioned effects and other unmentioned effects will be clearly understood by those skilled in the art from the following description.

### DESCRIPTION OF DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 is a view showing an example of a communication system applicable to the present disclosure.

FIG. 2 is a view showing an example of a wireless apparatus applicable to the present disclosure.

FIG. 3 is a view showing a method of processing a transmitted signal applicable to the present disclosure.

FIG. 4 is a view showing another example of a wireless device applicable to the present disclosure.

FIG. 5 is a view showing an example of a hand-held device applicable to the present disclosure.

FIG. 6 is a view showing physical channels applicable to the present disclosure and a signal transmission method using the same.

FIG. 7 is a view showing the structure of a radio frame applicable to the present disclosure.

FIG. 8 is a view showing a slot structure applicable to the present disclosure.

FIG. 9 is a view showing an example of a communication structure providable in a 6G system applicable to the present disclosure.

FIG. 10 is a view showing an example of an end-to-end multiuser precoding system.

FIG. 11 is a view showing an example of the end-to-end multiuser precoding system constructed by a neural network.

FIG. 12 is a view showing an example of an activation function used in a last layer of a user-side encoder neural network.

FIG. 13 is a view showing an example of a quantizer design scheme.

FIG. 14 is a view showing an example of a case where a probability distribution of the user-side encoder neural network is changed.

FIG. 15 is a view showing examples of a function which may be used as an STE and functions related thereto.

FIG. 16 is a view showing an example of a clipped identity function change aspect as training progresses.

FIG. 17 is a flowchart showing an example of a UE-BS signaling procedure for performing online learning proposed by the present disclosure.

FIG. 18 is a flowchart showing an example of a UE-BS signaling procedure for performing online learning proposed by the present disclosure.

FIGS. 19 and 20 are views for describing a generation process of a technical effect according to a method proposed by the present disclosure.

FIG. 21 is a flowchart showing an example of the method proposed by the present disclosure.

### MODE FOR DISCLOSURE

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a Base Station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an Advanced Base Station (ABS), an access point, etc.

In the embodiments of the present disclosure, the term terminal may be replaced with a UE, a Mobile Station (MS), a Subscriber Station (SS), a Mobile Subscriber Station (MSS), a mobile terminal, an Advanced Mobile Station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an UpLink (UL). Likewise, the mobile station may serve as a receiver and the BS may serve as a transmitter, on a DownLink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as Code Division Multiple Access (CDMA), Frequency Division Multiple Access (FDMA), lime Division Multiple Access (TDMA), Orthogonal Frequency Division Multiple Access (OFDMA), Single Carrier Frequency Division Multiple Access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

FIG. 1 is a view showing an example of a communication system applicable to the present disclosure. Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

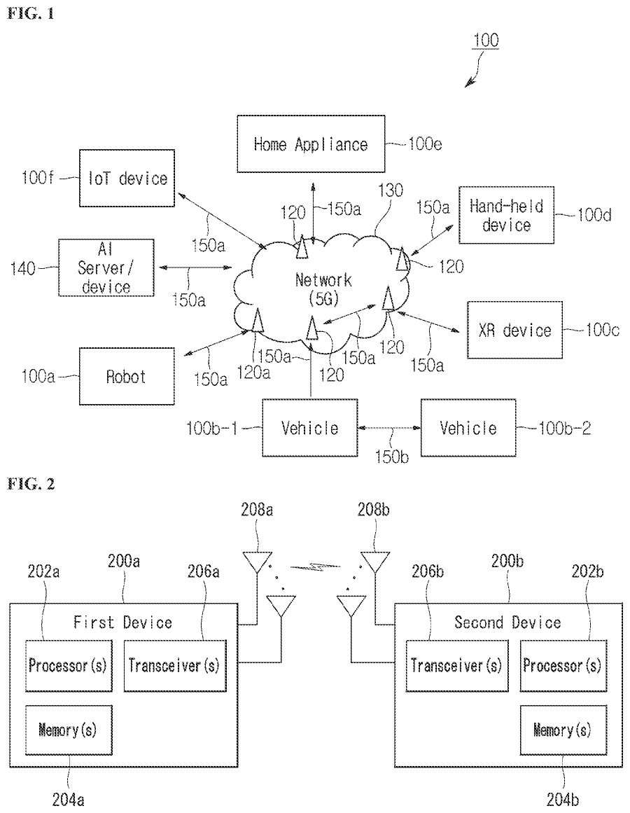

FIG. 2 is a view showing an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or (the wireless device 100x, the wireless device 100x) of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be connected with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be connected with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be connected with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be connected with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control). SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs. SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be connected with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be connected with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be connected with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be connected with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

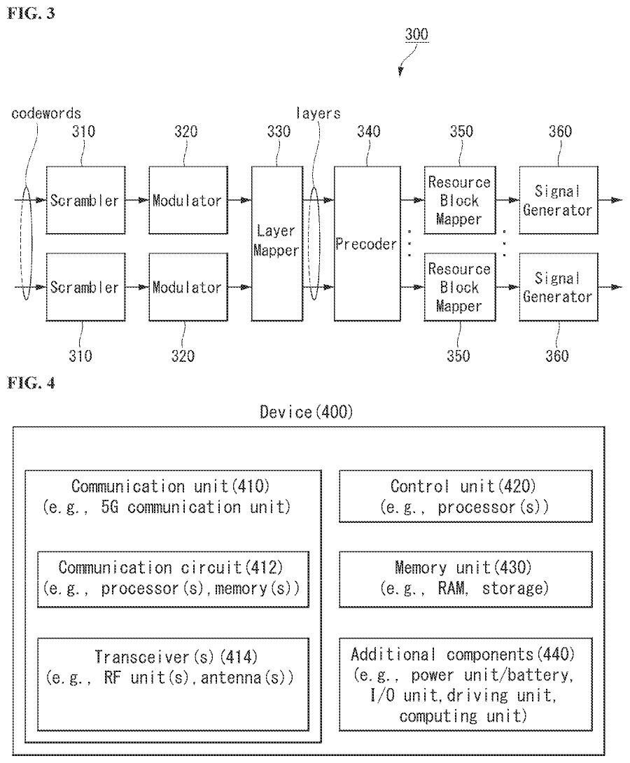

FIG. 3 is a view showing a method of processing a transmitted signal applicable to the present disclosure. For example, the transmitted signal may be processed by a signal processing circuit. At this time, a signal processing circuit 1200 may include a scrambler 300, a modulator 320, a layer mapper 330, a precoder 340, a resource mapper 350, and a signal generator 360. At this time, for example, the operation/function of FIG. 3 may be performed by the processors 202a and 202b and/or the transceiver 206a and 206b of FIG. 2. In addition, for example, the hardware element of FIG. 3 may be implemented in the processors 202a and 202b of FIG. 2 and/or the transceivers 206a and 206b of FIG. 2. In addition, for example blocks 310 to 350 may be implemented in the processors 202a and 202b of FIG. 2 and a block 360 may be implemented in the transceivers 206a and 206b of FIG. 2, without being limited to the above-described embodiments.

A codeword may be converted into a radio signal through the signal processing circuit 300 of FIG. 3. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH) of FIG. 6. Specifically, the codeword may be converted into a bit sequence scrambled by the scrambler 310. The scramble sequence used for scramble is generated based in an initial value and the initial value may include ID information of a wireless device, etc. The scrambled bit sequence may be modulated into a modulated symbol sequence by the modulator 320. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 330. Modulation symbols of each transport layer may be mapped to corresponding antenna port(s) by the precoder 340 (precoding). The output z of the precoder 340 may be obtained by multiplying the output y of the layer mapper 330 by an N*M precoding matrix W. Here, N may be the number of antenna ports and M may be the number of transport layers. Here, the precoder 340 may perform precoding after transform precoding (e.g., discrete Fourier transform (DFT)) for complex modulation symbols. In addition, the precoder 340 may perform precoding without performing transform precoding.

The resource mapper 350 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 360 may generate a radio signal from the mapped modulation symbols, and the generated radio signal may be transmitted to another device through each antenna. To this end, the signal generator 360 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 310 to 360 of FIG. 3. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### Structure of Wireless Device Applicable to the Present Disclosure

FIG. 4 is a view showing another example of a wireless device applicable to the present disclosure.

Referring to FIG. 4, a wireless device 400 may correspond to the wireless devices 200a and 200b of FIG. 2 and include various elements, components, units/portions and/or modules. For example, the wireless device 400 may include a communication unit 410, a control unit (controller) 420, a memory unit (memory) 430 and additional components 440. The communication unit may include a communication circuit 412 and a transceiver(s) 414. For example, the communication circuit 412 may include one or more processors 202a and 202b and/or one or more memories 204a and 204b of FIG. 2. For example, the transceiver(s) 414 may include one or more transceivers 206a and 206b and/or one or more antennas 208a and 208b of FIG. 2. The control unit 420 may be electrically connected with the communication unit 410, the memory unit 430 and the additional components 440 to control overall operation of the wireless device. For example, the control unit 320 may control electrical/mechanical operation of the wireless device based on a program/code/instruction/information stored in the memory unit 430. In addition, the control unit 420 may transmit the information stored in the memory unit 430 to the outside (e.g., another communication device) through the wireless/wired interface using the communication unit 410 over a wireless/wired interface or store information received from the outside (e.g., another communication device) through the wireless/wired interface using the communication unit 410 in the memory unit 430.

The additional components 440 may be variously configured according to the types of the wireless devices. For example, the additional components 440 may include at least one of a power unit/battery, an input/output unit, a driving unit or a computing unit. Without being limited thereto, the wireless device 400 may be implemented in the form of the robot (FIG. 1, 100a), the vehicles (FIG. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 4, various elements, components, units/portions and/or modules in the wireless device 400 may be connected with each other through wired interfaces or at least some thereof may be wirelessly connected through the communication unit 410. For example, in the wireless device 400, the control unit 420 and the communication unit 410 may be connected by wire, and the control unit 420 and the first unit (e.g., 130 or 140) may be wirelessly connected through the communication unit 410. In addition, each element, component, unit/portion and/or module of the wireless device 400 may further include one or more elements. For example, the control unit 420 may be composed of a set of one or more processors. For example, the control unit 420 may be composed of a set of a communication control processor, an application processor, an electronic control unit (ECU), a graphic processing processor, a memory control processor, etc. In another example, the memory unit 430 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

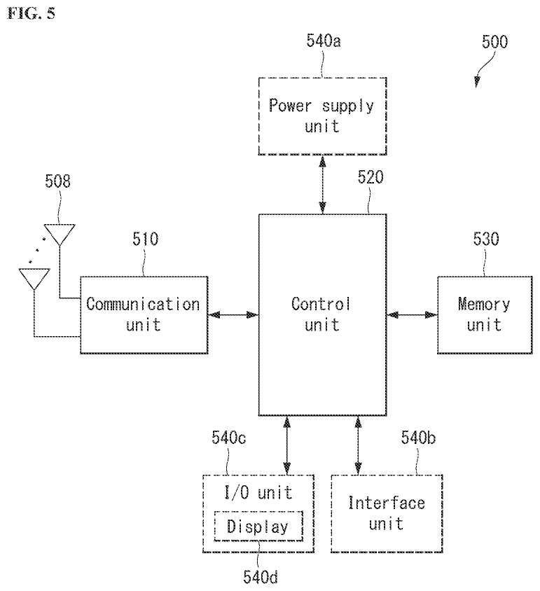

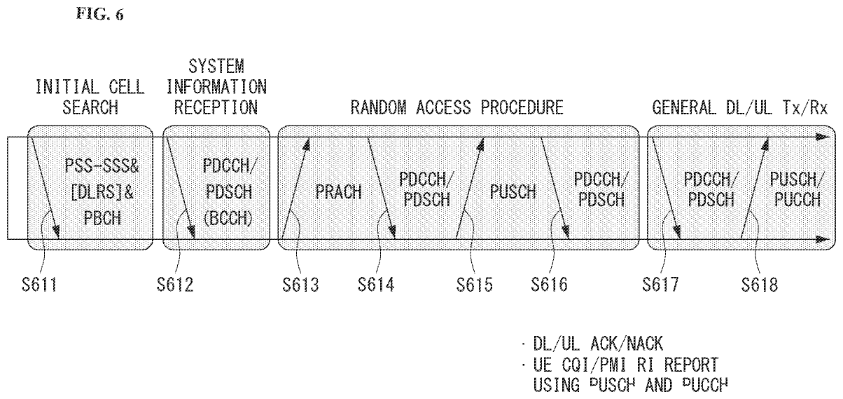

FIG. 5 is a view showing an example of a hand-held device applicable to the present disclosure.

FIG. 5 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 5, the hand-held device 500 may include an antenna unit (antenna) 508, a communication unit (transceiver) 510, a control unit (controller) 520, a memory unit (memory) 530, a power supply unit (power supply) 540a, an interface unit (interface) 540b, and an input/output unit 540c. An antenna unit (antenna) 508 may be part of the communication unit 510. The blocks 510 to 530/540a to 540c may correspond to the blocks 410 to 430/440 of FIG. 4, respectively.

The communication unit 510 may transmit and receive signals (e.g., data, control signals, etc.) to and from other wireless devices or base stations. The control unit 520 may control the components of the hand-held device 500 to perform various operations. The control unit 520 may include an application processor (AP). The memory unit 530 may store data/parameters/program/code/instructions necessary to drive the hand-held device 500. In addition, the memory unit 430 may store input/output data/information, etc. The power supply unit 540a may supply power to the hand-held device 500 and include a wired/wireless charging circuit, a battery, etc. The interface unit 540b may support connection between the hand-held device 500 and another external device. The interface unit 540b may include various ports (e.g., an audio input/output port and a video input/output port) for connection with the external device. The input/output unit 440c may receive or output video information/signals, audio information/signals, data and/or user input information. The input/output unit 540c may include a camera, a microphone, a user input unit, a display 540d, a speaker and/or a haptic module.

For example, in case of data communication, the input/output unit 540c may acquire user input information/signal (e.g., touch, text, voice, image or video) from the user and store the user input information/signal in the memory unit 530. The communication unit 510 may convert the information/signal stored in the memory into a radio signal and transmit the converted radio signal to another wireless device directly or transmit the converted radio signal to a base station. In addition, the communication unit 510 may receive a radio signal from another wireless device or the base station and then restore the received radio signal into original information/signal. The restored information/signal may be stored in the memory unit 530 and then output through the input/output unit 540c in various forms (e.g., text, voice, image, video and haptic).

### Physical Channels and General Signal Transmission

In a radio access system, a UE receives information from a base station on a DL and transmits information to the base station on a UL. The information transmitted and received between the UE and the base station includes general data information and a variety of control information. There are many physical channels according to the types/usages of information transmitted and received between the base station and the UE.

FIG. 5 is a view showing physical channels applicable to the present disclosure and a signal transmission method using the same.

The UE which is turned on again in a state of being turned off or has newly entered a cell performs initial cell search operation in step S1011 such as acquisition of synchronization with a base station. Specifically, the UE performs synchronization with the base station, by receiving a Primary Synchronization Channel (P-SCH) and a Secondary Synchronization Channel (S-SCH) from the base station, and acquires information such as a cell Identifier (ID).

Thereafter, the UE may receive a physical broadcast channel (PBCH) signal from the base station and acquire intra-cell broadcast information. Meanwhile, the UE may receive a downlink reference signal (DL RS) in an initial cell search step and check a downlink channel state. The UE which has completed initial cell search may receive a physical downlink control channel (PDCCH) and a physical downlink control channel (PDSCH) according to physical downlink control channel information in step S612, thereby acquiring more detailed system information.

Thereafter, the UE may perform a random access procedure such as steps S613 to S616 in order to complete access to the base station. To this end, the UE may transmit a preamble through a physical random access channel (PRACH) (S613) and receive a random access response (RAR) to the preamble through a physical downlink control channel and a physical downlink shared channel corresponding thereto (S614). The UE may transmit a physical uplink shared channel (PUSCH) using scheduling information in the RAR (S615) and perform a contention resolution procedure such as reception of a physical downlink control channel signal and a physical downlink shared channel signal corresponding thereto (S616).

The UE, which has performed the above-described procedures, may perform reception of a physical downlink control channel signal and/or a physical downlink shared channel signal (S617) and transmission of a physical uplink shared channel (PUSCH) signal and/or a physical uplink control channel (PUCCH) signal (S618) as general uplink/downlink signal transmission procedures.

The control information transmitted from the UE to the base station is collectively referred to as uplink control information (UCI). The UCI includes hybrid automatic repeat and request acknowledgement/negative-ACK (HARQ-ACK/NACK), scheduling request (SR), channel quality indication (CQI), precoding matrix indication (PMI), rank indication (RI), beam indication (BI) information, etc. At this time, the UCI is generally periodically transmitted through a PUCCH, but may be transmitted through a PUSCH in some embodiments (e.g., when control information and traffic data are simultaneously transmitted). In addition, the UE may aperiodically transmit UCI through a PUSCH according to a request/instruction of a network.

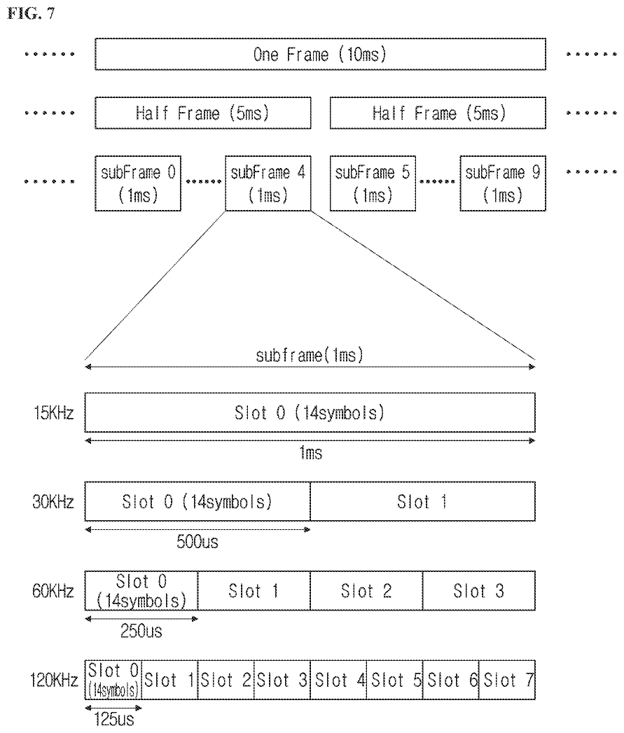

FIG. 7 is a view showing the structure of a radio frame applicable to the present disclosure.

UL and DL transmission based on an NR system may be based on the frame shown in FIG. 7. At this time, one radio frame has a length of 10 ms and may be defined as two 5-ms half-frames (HFs). One half-frame may be defined as five 1-ms subframes (SFs). One subframe may be divided into one or more slots and the number of slots in the subframe may depend on subscriber spacing (SCS). At this time, each slot may include 12 or 14 OFDM(A) symbols according to cyclic prefix (CP). If normal CP is used, each slot may include 14 symbols. If an extended CP is used, each slot may include 12 symbols. Here, the symbol may include an OFDM symbol (or a CP-OFDM symbol) and an SC-FDMA symbol (or a DFT-s-OFDM symbol).

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 2 | 12 | 40 | 4 |

| μ | N_{symb}^{slot} | Nₛₗₒₜ^{frameμ} | Nₛₗₒₜ^{subframeμ} |
|---|---|---|---|
| 2 | 12 | 40 | 4 |

In Tables 1 and 2 above, Nslotsymb may indicate the number of symbols in a slot, Nframe,μslot may indicate the number of slots in a frame, and Nsubframe,μslot may indicate the number of slots in a subframe.

In addition, in a system, to which the present disclosure is applicable, OFDM(A) numerology (e.g., SCS, CP length, etc.) may be differently set among a plurality of cells merged to one UE. Accordingly, an (absolute time) period of a time resource (e.g., an SF, a slot or a TTI) (for convenience, collectively referred to as a time unit (TU)) composed of the same number of symbols may be differently set between merged cells.

NR may support a plurality of numerologies (or subscriber spacings (SCSs)) supporting various 5G services. For example, a wide area in traditional cellular bands is supported when the SCS is 15 kHz, dense-urban, lower latency and wider carrier bandwidth are supported when the SCS is 30 kHz/60 kHz, and bandwidth greater than 24.25 GHz may be supported to overcome phase noise when the SCS is 60 kHz or higher.

An NR frequency band is defined as two types (FR1 and FR2) of frequency ranges. FR1 and FR2 may be configured as shown in the following table. In addition, FR2 may mean millimeter wave (mmW).

| Frequency Range | Corresponding | | |
|---|---|---|---|
| designation | frequency range | Subcarrier Spacing | |
| FR1 | 410 MHz-7125 MHz | 15, 30, 60 | kHz |
| FR2 | 24250 MHz-52600 MHz | 60, 120, 240 | kHz |

In addition, for example, in a communication system, to which the present disclosure is applicable, the above-described numerology may be differently set. For example, a terahertz wave (THz) band may be used as a frequency band higher than FR2. In the THz band, the SCS may be set greater than that of the NR system, and the number of slots may be differently set, without being limited to the above-described embodiments. The THz band will be described below.

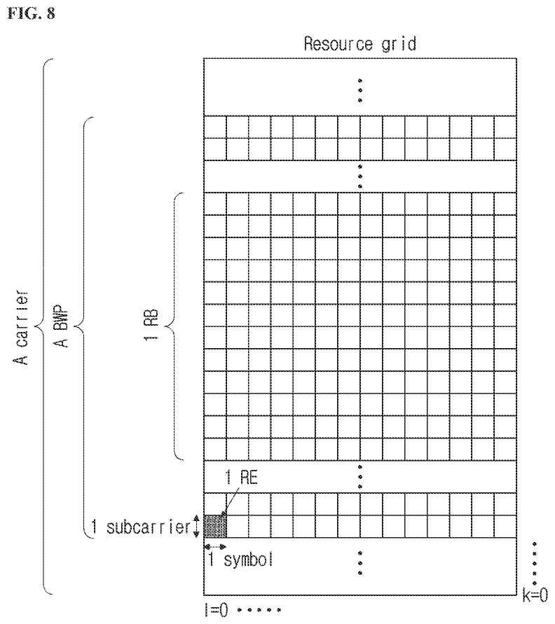

FIG. 8 is a view showing a slot structure applicable to the present disclosure.

One slot includes a plurality of symbols in the time domain. For example, one slot includes seven symbols in case of normal CP and one slot includes six symbols in case of extended CP. A carrier includes a plurality of subcarriers in the frequency domain. A resource block (RB) may be defined as a plurality (e.g., 12) of consecutive subcarriers in the frequency domain.

In addition, a bandwidth part (BWP) is defined as a plurality of consecutive (P)RBs in the frequency domain and may correspond to one numerology (e.g., SCS, CP length, etc.).

The carrier may include a maximum of N (e.g., five) BWPs. Data communication is performed through an activated BWP and only one BWP may be activated for one UE. In resource grid, each element is referred to as a resource element (RE) and one complex symbol may be mapped.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity and (vii) connected intelligence with machine learning capacity. The vision of [symbol] “deep [symbol] G system [symbol] requirements

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

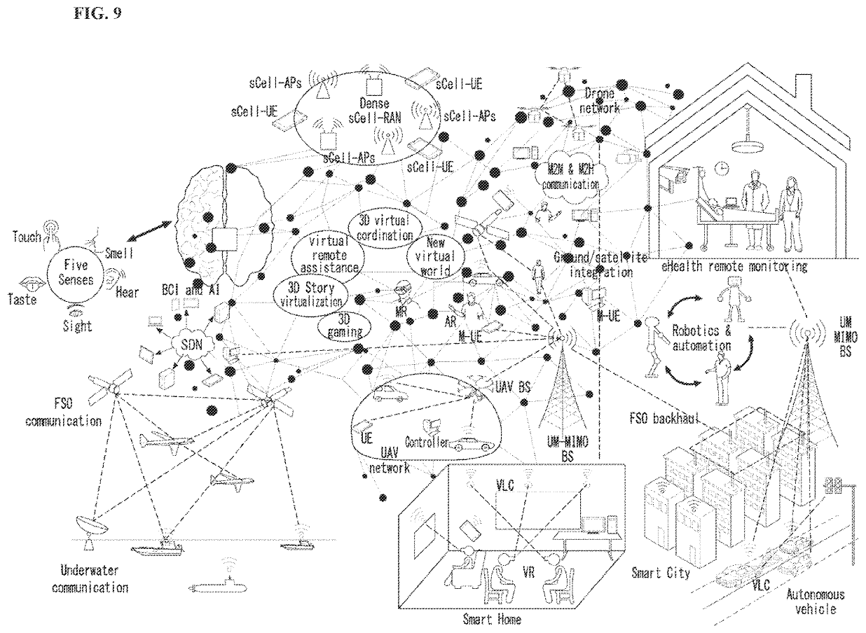

FIG. 9 is a view showing an example of a communication structure providable in a 6G system applicable to the present disclosure.

Referring to FIG. 9, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In addition, in 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimension connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduce costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability.

### DEFINITION OF TERMS

For convenience of description, the following symbols/abbreviations/terms may be used interchangeably in the present disclosure.
CSI: Channel State Information
NN: (artificial) Neural Network
DNN: Deep Neural Network
AWGN: Additive white Gaussian noise
FDD: Frequency Division Duplex)
BS: Base Station
PDF: Probability Density Function
QoS: Quality of Service
STE: Straight-Through Estimator
tan h: Hyperbolic tangent function

Hereinafter, characters expressed as forms such as x, X, X and [symbol] mean scalar, vector, matrix, and set, respectively. Furthermore, [symbol] represents a complex set, and [symbol] represents a complex space of m by n dimensions. I means an identity matrix having appropriate dimensions.

[symbol] represents a Hermitian transpose, Tr(·) and [symbol] [·] represent a trace and an expectation operator, respectively. ∥·∥_{g} represents a Euclidean norm of a vector. [symbol] (0, R) represents a zero-mean circularly symmetric complex Gaussian distribution having R as a covariance matrix.

Prior to describing the methods proposed by the present disclosure in earnest, an end-to-end multiuser precoding system is first described.

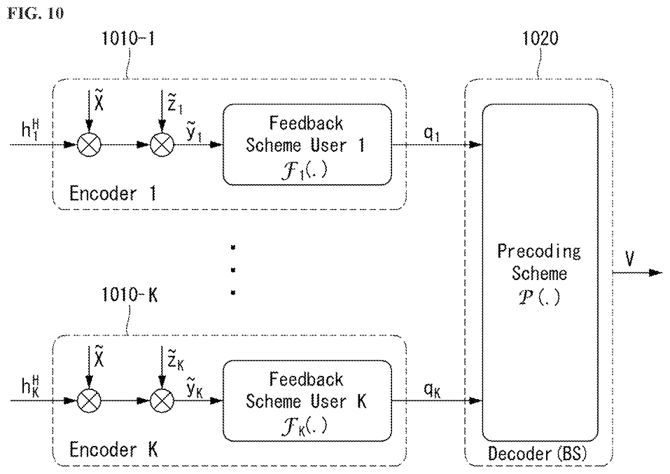

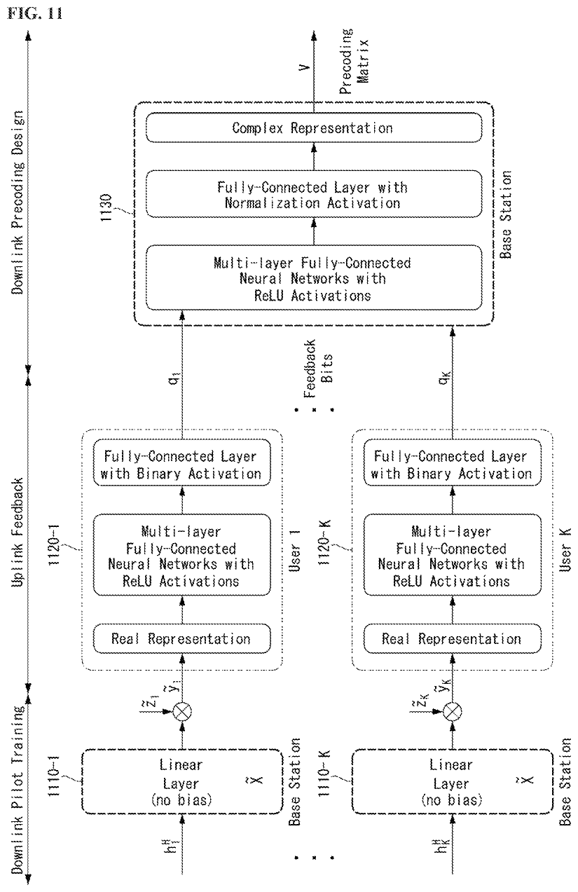

FIG. 10 is a view showing an example of an end-to-end multiuser precoding system.

More specifically, FIG. 10 relates to an example of a multiuser precoding system constituted by a total of K user-side encoders and a base station-side decoder.

Referring to FIG. 10 reference numerals 1010-1 to 1010-K represent the user-side encoders, and reference numeral 1020 represents the base station-side decoder.

Method proposed by the present disclosure described below may be understood to consider a downlink precoding system assuming frequency-division duplex (FDD) and finite feedback rate (rate-limited feedback). Furthermore, it may be understood that assumed is a situation in which the number of transmit antennas of the base station is M and there are K single-antenna users, and in this case, it is assumed that a relationship of K<M is satisfied.

In FIG. 10, a signal transmitted by the base station may be denoted by x, a symbol for a k-th user may be denoted by sₖ, and a precoding vector for the k-th user may be denoted by vₖ∈ [symbol] . In this case, a precoding matrix V having vₖ as a k-th column may be defined, and V∈ [symbol] may be satisfied. Further, a vector s having the symbol for the k-th user, sₖ as a k-th element may be defined, and in this case, a transmit signal may be expressed as x=Σₖ₌₁^{K}vₕsₜ=Vs. That is, the base station may perform linear precoding. Here, in general, constraints such as T(VV^{H})≤P [total power constraint] and [symbol] [symbol] ]=I [no correlation between symbols of different users, each symbol normalized] may be given with respect to precoding and symbols.

Downlink channel gains between the base station and the k-th user may be defined as hₖ∈ [symbol] , and in this case, narrowband block-fading may be assumed. A signal received by the k-th user may be expressed as yₖ=hₖ^{N}vₖzₖsₖ+Σₗ₌ₖh_{z}^{H}vⱼsⱼ+zₖ. Here, zₖ˜e [symbol] (0ₓσ²) represents an additive white Gaussian noise (AWGN) in the k-th user. As a result, an achievable rate of the k-th user may be calculated as in the following equation.

$${R}_{k} = {log}_{2} ( 1 + \frac{{\vert {h}_{k}^{H} {v}_{k} \vert}^{2}}{{\sum }_{j \neq k} {\vert {h}_{k}^{H} {v}_{j} \vert}^{2} + {σ}^{2}} ) \qquad [ Equation 1 ]$$

In order to achieve the achievable rate which is a theoretical value in an actual communication situation, an additional technique may be appropriately used in addition to the method proposed by the present disclosure, and various quality of services (QoS) other than the achievable rate may be considered as an indicator of communication performance.

Encoders and decoders shown in FIG. 10 may be appropriately designed in order to maximize Sum rate R=ΣₖRₖ (or optimize another communication QoS), and a neural network (NN) constituted by the encoders and the decoders is constructed and trained to obtain optimal encoders and decoders.

Prior to a data transmission phase, in a downlink training phase, the base station transmits downlink training pilots \tilde{X}∈ [symbol] having a pilot length of L. An l-th column of \tilde{x}, i.e., I-th pilot transmission \tilde{x}ₗ satisfies a per-transmission power constraint (∥\tilde{x}ᵢ∥₂²≤P). In this case, a signal \tilde{y}ₖ∈ [symbol] having the length of L received and observed by user k may be expressed as in the following equation.

$$\tilde{{y}_{k}} = {h}_{k}^{H} \tilde{X} + \tilde{{z}_{k}} \qquad [ Equation 2 ]$$

Here, \tilde{z}ₖ˜ [symbol] (0,σ²l), represents the AWGN in user k.

In FIG. 10, an encoder of user k receives \tilde{y}_{b}∈ [symbol] as an input, and outputs B information bits. Here, B may be a natural number. Here, a rule (or function) used for the encoder of user K to receive \tilde{y}ₖ∈ [symbol] as the input and output B information bits is [symbol] ₁ [symbol] →[±1]² which is a feedback scheme selected in user k. That is, feedback bits of user k may be expressed as qₖ= [symbol] ₖ(\tilde{y}ₖ).

In FIG. 10, the decoder of the base station receives feedback bits q≙[qₖ^{T}, . . . , qₖ^{T}]^{T} received from all of K users as the input, and generates a precoding matrix V∈ [symbol] as an output. A function used for the decoder to receive the feedback

$$\tilde{x} , {maximize}_{{\{ {ℱ}_{k} ( \cdot ) \}}_{∀ k} , 𝒫 ( \cdot )} {\sum }_{k = 1}^{K} {log}_{2} ( 1 + \frac{{\vert {h}_{k}^{H} {v}_{k} \vert}^{2}}{{\sum }_{j \neq k} {\vert {h}_{k}^{H} {v}_{j} \vert}^{2} + {σ}^{2}} ) atrix V as the output is a$$

$$subject to$$

$$V = 𝒫 ( {[ {q}_{1}^{T} , … , {q}_{K}^{T} ]}^{T} ) , ling system in FIG . 10 may$$

$${q}_{k} = {ℱ}_{k} ( {h}_{k}^{H} \tilde{X} + {\tilde{z}}_{k} ) , ∀ k , 1 the following equation .$$

$$Tr ( {VV}^{H} ) \leq P ,$$

$${‖ {\tilde{x}}_{ℓ} ‖}_{2}^{2} \leq P , ∀ ℓ$$

In addition to the sum rate, various other communication QoS may be used as an objective function sum, of course.

As expressed in Equation 3 above, a design of the end-to-end multiuser precoding system may be understood as a process of finding a combination of maximizing the sum rate (or optimize another QoS) with respect to three following items.
\tilde{x}: Downlink training pilots
( [symbol] ₖ(·))]_{∀k}: Feedback schemes at users
[symbol] (·): Precoding scheme at BS

Referring to Equation 3 above, it can be seen that a training pilot \tilde{x} transmitted by the base station is a variable for optimization in addition to the feedback scheme used at each user and the precoding scheme used by the base station.

As a method for finding an optimized end-to-end FDD downlink precoding system, deep learning may be used. That is, the downlink training pilots) \tilde{x}, the feedback schemes at users { [symbol] ₖ(·)}_{∀k}, and the precoding scheme in the base station [symbol] (·) are all constituted by the neural network, and the constructed neural network is trained to obtain neural network parameters.

FIG. 11 is a view showing an example of the end-to-end multi-user precoding system constructed by a neural network. Here, the term “end-to-end” means jointly optimizing (i) channel estimation, (ii) compression, (iii) feedback, and (iv) functional building blocks (or modules) separated in conventional CSI feedback schemes, respectively rather than meaning from the user-side to the base station-side. That is, it may be understood that in the end-to-end, a first end corresponds to downlink pilots (signals) (i.e., (i) channel estimation), a second end corresponds to (ii) compression, a third end corresponds to (iii) feedback, and a last end corresponds to an output of the precoding vector. Hereinafter, when there is no separate description, the term “end-to-end” may be used for representing the above-described meaning.

Referring to FIG. 11, reference numerals 1110-1 to 1110-K represent downlink training pilots X̅ transmitted to K users from the base station, respectively, reference numerals 1120-1 to 1120-K represent feedback schemes { [symbol] (·)}_{∀k} users, and reference numeral 1130 represents a precoding scheme [symbol] (·) in the base station.

A binary activation layer may be used so as for a last layer of a user-side encoder neural network to output a binary value as represented by reference numerals 1120-1 to 1120-K. Outputting the binary value may mean making each component of qₖ∈[±1]^{E} have bipolar feedback bits.

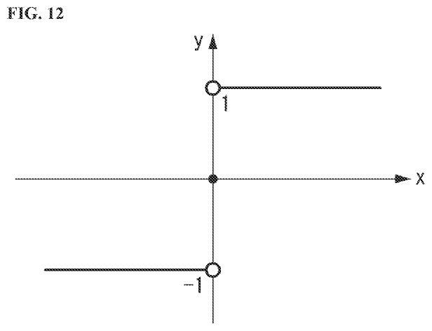

FIG. 12 is a view showing an example of an activation function used in a last layer of a user-side encoder neural network.

Referring to FIG. 12, a sign function (signum function) may be used as the activation function used in the last layer of the user-side encoder neural network.

Referring back to FIG. 11, in a neural network structure shown in FIG. 11, when feedback capacities B (i.e., the number of feedback bits) in respective users are different, the number of neurons of the last layer of each user-side encoder neural network varies according to the different number of feedback bits. A generalized method is required in which a common neural network structure may be used with respect to a feedback bit number B. That is, an end-to-end multiuser downlink precoding system may be considered in which the same neural network structure may be used even though a feedback rate limit B varies.

That is, a change in neural network structure shown in FIG. 11 may be required so as to use the same neural network structure regardless of variation of the number of feedback bits at the users. More specifically, the activation function for the last layer of each user-side encoder neural network may be replaced with a hyperbolic tangent (tan h) function in the signum function described in FIG. 12 above. Further, the user-side encoder neural network may be configured to have S neurons. Here, the tan h function is just one example, and other functions may be used as the activation function for the last layer of the user-side encoder neural network, of course. S soft-valued outputs are generated for each user-side encoder neural network, and when a tan h function is used as the activation function for the last layer of the user-side encoder neural network, values output from S neurons may be real numbers in a range of [−1, 1].

When S real numbers are generated for each user, each real number may be quantized in Q bits. Accordingly, a bit number which is as large as B=S×Q may be used for feedback for each user. Accordingly, even though the dimension of the output of each user-side encoder neural network is fixed to S, the Q value may be appropriately set according to B which is a per-user feedback bit number, and as a result, a feedback rate may be fluidly supported even though the neural network structure is fixed.

In this case, a quantizer for appropriately quantizing S real numbers output from respective users is required. To this end, hereinafter, it is assumed that the changed overall neural network structure (i.e., a neural network structure in which the output of the user-side encoder neural network does not have the binary value, but has the real number) is sufficiently trained. When the training of the neural network is completed, an empirical probability density function (PDF) may be obtained with respect to the output of the user-side encoder neural network. The quantizer for quantizing the output of the user-side encoder neural network may be designed by applying a Lloyd-Max algorithm to the empirical PDF. Another scheme other than the scheme of applying the Lloyd-Max algorithm to the PDF may be applied for designing the quantizer, of course.

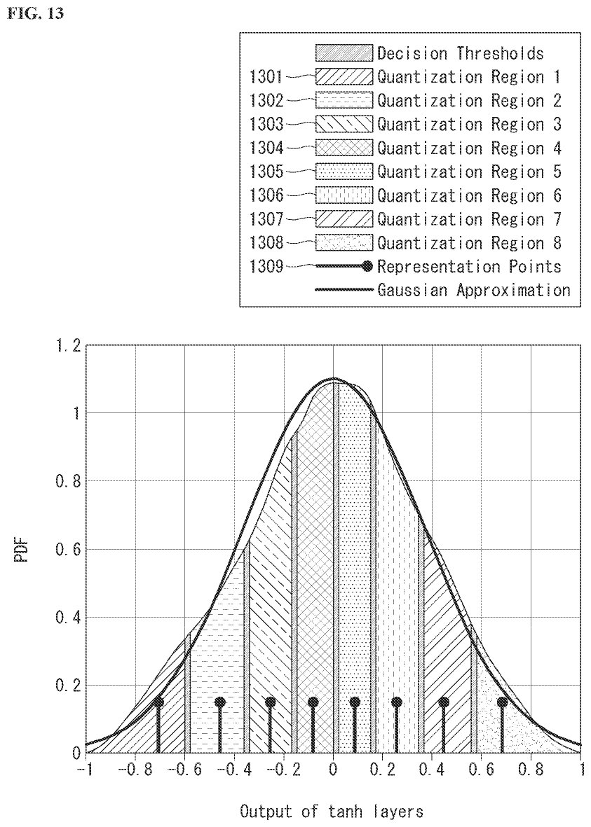

FIG. 13 is a view showing an example of a quantizer design mode.

More specifically, FIG. 13 is a view related to an example of a quantizer designed by acquiring an empirical PDF for the output of the user-side encoder neural network, and applying a Lloyd-Max algorithm to the acquired empirical PDF. Referring to FIG. 13, a total of 8 quantization regions may be divided by 7 decision thresholds. That is, reference numerals 1301 to 1308 represent that a value of the output of the user-side encoder neural network is quantized into 8 values. Since a real number value is quantized into 8 values, the number of quantization bits may become 3 bits. In FIG. 13, reference numeral 1309 represent representative points of respective quantization regions. The respective quantization regions and representative values of the respective quantization regions may be expressed as a quantization rule, and the quantization rule means a partition and a codebook. More specifically, the partition may mean decision thresholds (and quantization regions divided by the decision thresholds), the codebook may mean representative levels, and the representative levels may be representative points.

When it is assumed that the user-side and the base station-side know the quantization rule in advance, outputs (S real numbers) of the respective user-side encoder neural networks may be quantized into Q bits according to the quantization rule, and transmitted to the base station. Accordingly, the respective users may transmit a bit number which is as large as B=S×Q as feedback. The base station may receive B bits transmitted from the respective users, and restore the bits to S real numbers again according to the quantization rule. Here, the restored real number may be one of 2^{Q} representative levels present in the codebook. K×S real numbers which the base station receives and restores from K users may be input into the base station-side decoder neural network. In this case, an input signal of the base station-side decoder neural network is constituted by a Q-bit quantized version in which output signals (S real numbers) of the respective user-side encoder neural networks are quantized into Q bits. In this case, while neural network parameters of the respective user-side encoder neural networks are fixed, a neural network parameter of a base station-side decoder neural network may be trained so as for the base station-side decoder neural network to output an optimal precoding matrix. Here, (training) data input into the base station-side decoder neural network for training may be constituted by Q-bit quantized versions in which output signals (S real numbers) of the respective user-side encoder neural networks are quantized into Q bits.

As described above, it is assumed that the changed overall neural network structure (i.e., the neural network structure in which the user-side encoder neural network does not have the binary value any longer, but has the real number) is sufficiently trained, and as a result, the user-side encoder neural network in the overall neural network structure may use an already trained parameter as it is. On the contrary, since the base station-side decoder neural network is trained according to a situation in which a real number which is not quantized is input as the input signal as it is, the base station-side decoder neural network should perform a process of newly training to fit an input of the quantized version. That is, when up to the process of newly training the base station-side decoder neural network to fit the input of the quantized version is sufficiently conducted, encoder/decoder neural networks correspond to the user side and the base station side, respectively may be deployed each other jointly with a pre-defined quantization rule for downlink precoding in actual communication. Meanwhile, when the end-to-end multiuser precoding system is used in the actual communication, if the probability distribution of the output of the user-side encoder neural network varies, there is a problem in that a new quantization rule (partition and codebook) is required whenever the probability distribution of the output of the user-side encoder neural network varies. That is, the precoding system may be normally actuated only when the quantization rule obtained from the probability distribution of the output of the user-side encoder neural network (through the Lloyd-Max algorithm) should be present in both the user side and the base station side.

The problem which occurs in the precoding system due to the varied probability distribution of the output of the user-side encoder neural network may occur in three following cases. Three following cases show a situation in which the probability distribution of the output of the user-side encoder neural network is changed or varied.

### (1) Different Users

In general, in the case of different users, since channel characteristics from the base station to the user are different from each other, probability distributions of inputs into respective user-side encoder neural networks are different, and as a result, neural network parameters of the respective user-side encoder neural networks are also different from each other. Since the probability distributions of the inputs into the user-side encoder neural networks between the users are different from each other, and neural network parameters in the user-side encoder neural networks are different from each other, the probability distributions of the outputs of the user-side encoder neural networks are different.

### (2) Training Phase

In a training process for the user-side encoder neural network, the neural network parameter is optimized as time elapses (training progresses), and as a result, the probability distribution of the output of the user-side encoder neural network is varied.

### (3) Time-Varying Channel Characteristics

Channel characteristics between each user and the base station may be varied according to the time by a factor such as mobility of the user. When the channel characteristics are varied, the probability distribution of the input of each user-side encoder neural network is varied, and the neural network parameter of each user-side encoder neural network should be further performed according to the varied probability distribution of the input of the user-side encoder neural network. As the neural network parameter of the user-side encoder neural network is further optimized, the probability distribution of the output of the user-side encoder neural network is also varied.

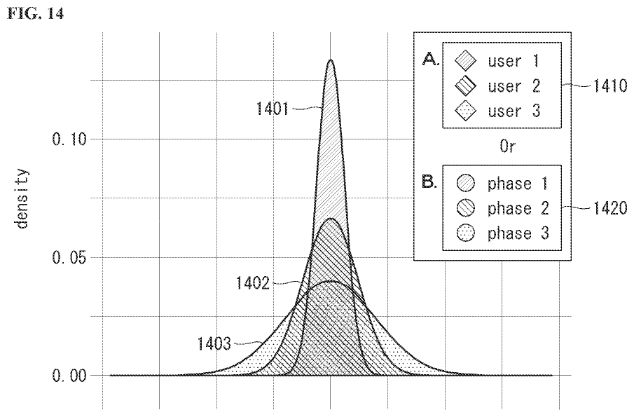

Referring to FIG. 14, a case where the probability distribution of the output of the user-side encoder neural network is changed is additionally described.

FIG. 14 is a view showing an example of a case where a probability distribution of the user-side encoder neural network is changed.

First, referring to FIG. 14, in the case of a graph interpretation shown in FIG. 14 according to reference numeral 1410, a graph shown in FIG. 14 may be interpreted from a viewpoint for a case where the probability distribution of the output of the user-side encoder neural network is varied due to differences in channel characteristics between different users and the base station. That is, in the graph shown in FIG. 14, it may be interpreted that reference numerals 1401 to 1403 represent probability distributions of outputs of user-side encoder neural networks of respective different users. Here, it may be understood that graphs represented by reference numerals 1401 to 1403 which show different types of probability distributions are based on the differences in channel characteristics between the respective users and the base station.

Next, in the case of a graph interpretation shown in FIG. 14 according to reference numeral 1420, the graph shown in FIG. 14 may be interpreted from a viewpoint for a case where the probability distribution of the output of the user-side encoder neural network is varied as the neural network parameter is optimized according to the training of the user-side encoder neural network. That is, in the graph shown in FIG. 14, it may be interpreted that reference numerals 1401 to 1403 represent that a probability distribution of an output of a user-side encoder neural network of one specific user is varied as the neural network parameter is optimized according to the training of the user-side encoder neural network. Here, the graphs represented by reference numerals 1401 to 1403 which show different types of probability distributions may be understood that the neural network parameter of the user-side encoder neural network of one specific user is varied as the neural network parameter is optimized according to the training of the user-side encoder neural network, and as a result, the probability distribution of the output of the user-side encoder neural network is varied.

When the probability distribution of the output of the user-side encoder neural network is varied, two following approach schemes may be considered in order to identify a quantization rule which is changed at both the user side and the base station side according to the varied probability distribution.
(Approach scheme 1) A procedure in which the changed quantization rules are exchanged between the user side and the base station side whenever the quantization rule is changed due to the variation of the probability distribution of the output of the user-side encoder neural network. In this case, the procedure in which the changed quantization rules are exchanged between the user side and the base station side may be performed by a scheme of defining the quantization rule at the user side and transmitting information on the defined quantization rule to the base side.
(Approach scheme 2) The quantization rule is predefined in advance with respect to each of probability distributions in all cases which the output of the user-side encoder neural network may have. Here, the predefined quantization rule may be stored in advance at both the user side and the base station side. Thereafter, when the probability distribution of the output of the user-side encoder neural network is varied, the user side may announce information on the varied probability distribution to the base station side. In this case, an appropriate quantization rule may be identified through a mapping relationship between the predefined quantization rule and the probability distributions of all cases which the output of the user-side encoder neural network may have based on the information on the varied probability distribution.
In the case of (Approach scheme 1), the user side may need an additional processing time in order to obtain the quantization rule prior to transmission of the quantization rule to the base station side, and there may be a limit that signaling overhead for transmission of the quantization rule may also be significant.
In the case of (Approach scheme 2), an empirical PDF having a large number of cases is obtained in advance, and all quantization rules corresponding to the empirical PDF should be defined, and there is a limit in which there is inefficiency that the user side and the base station side should store the quantization rules for all of the cases.

Meanwhile, when the probability distribution of the output of the user-side encoder neural network is changed, neural network parameters of an overall neural network constituted by the user-side encoder neural network and the base station-side decoder neural network should be appropriately adapted according to a situation in which the probability distribution of the output of the user-side encoder neural network is changed. That is, an additional training procedure may be required as the probability distribution of the output of the user-side encoder neural network is changed. At a time when the probability distribution of the output of the user-side encoder neural network is changed, when there is a situation in which the base station-side decoder neural network is deployed prior to the user-side encoder neural network, additional training (e.g., fine tuning) cannot but be performed through online learning.

Accordingly, the present disclosure proposes an online learning method which may overcome limits of (Approach scheme 1) and (Approach scheme 2). Online learning schemes on the framework described above may be organized into two following types based on whether a quantization layer as a final output layer of the user-side encoder neural network being present in the user-side encoder neural network.

### (i) Post-Training Quantization & Re-Training Scheme

In this scheme, real number value outputs of the respective user-side encoder neural networks are input into the base station-side decoder neural network as they are without quantization, so the user-side encoder neural network and the base station-side decoder neural network are trained. Thereafter, when training of the scheme of inputting the real number value outputs of the user-side encoder neural network into the base station-side decoder neural network as they are without quantization is completed, the neural network parameters of the base station-side decoder neural network are re-trained in the scheme of quantizing an output value of each user-side encoder neural network and inputting the quantized output value into the base station-side decoder neural network while fixing the neural network parameters of the respective user-side encoder neural networks.

### (ii) Quantization-Aware Training Scheme

In this scheme, a final layer of the user-side encoder neural network itself is constructed by an activation function corresponding to quantization. Accordingly, the quantization is included in the neural network structure itself. The output of the user-side encoder neural network is a value output via the quantization layer which is the last layer of the encoder neural network. That is, a final output of the encoder neural network is a value acquired by quantizing a value of a previous layer of the final layer. Accordingly, the quantization layer is handled and trained as one layer included in the overall neural network.

In general, post-training quantization may have an advantage over the quantization-aware training in terms of training efficiency. That is, a training time of the post-training quantization may be shorter than that of the quantization-aware training. On the contrary, the post-training quantization may have a disadvantage in which re-training is required. Furthermore, the quantization-aware training is generally more excellent than the post-training quantization in terms of performance of a system represented as model accuracy. In particular, in the case of the online learning, an aspect of signaling overhead should be preferentially considered, and when the output value of the user-side encoder neural network is transmitted to the base side, the output of the user-side encoder neural network in the case of the quantization-aware training is transmitted as a lower-precision value than the output value of the user-side encoder neural network in the case of the post-training quantization. Accordingly, saving of signaling overhead in the quantization-aware training larger than that in the post-training quantization training may be expected.

In the present disclosure, the online learning is considered, and the online learning is limitatively performed in a wireless communication environment due to finite radio resources. Accordingly, the method proposed by the present disclosure may be more preferably applied than a case where fine tuning in a situation in which training is conducted at a predetermined level or more or adaptation to a change of the output distribution of the user-side encoder neural network, which is not extreme is performed. The fine tuning or adaptation often aims at a viewpoint of performance maintaining of the precoding system rather than the training efficiency, and reduction of the signaling overhead is requisitely required in such a viewpoint.

Accordingly, the present disclosure proposes an online learning method of the quantization-aware scheme for overcoming the limits of Approach schemes 1) and 2). That is, according to the online learning method for the end-to-end multiuser precoding system of the quantization-aware scheme proposed by the present disclosure, a processing time required for obtaining the quantization rule and the signaling overhead may be more remarkably reduced than (Approach scheme 1), and quantization rule storing inefficiency in (Approach scheme 2) may be resolved.

It is assumed that methods proposed by the present disclosure described below may be preferably applied to a situation in which quantization-aware online learning is inevitable, and it is effective to perform the quantization-aware online learning. Furthermore, it is assumed that the probability distribution of the user-side encoder neural network is excellently approximated to a zero-mean Gaussian distribution, and effective training may be performed even though training is conducted by using the quantization rule based on the approximated Gaussian distribution instead of an accurate empirical PDF at both the user side and the base station side. Hereinafter, it may be understood that the user side indicates user equipment, and it may be understood that the base station side indicates the base station. An expression such as the user equipment/base station may be understood as meaning the user side/base station side.

### Signaling Information—(Method 1)

In the method, three characteristic types of information which should be exchanged between the user equipment and the base station to perform the online learning proposed by the present disclosure is described. More specifically, the three types of information may include a variance for a probability distribution of an output of the user equipment, epoch-specific information, and a coarse gradient.

### Variance (Empirically Calculated) of User-Side Encoder NN Output Distribution

As shown in FIG. 13, the probability distribution of the output of the user-side encoder neural network may be excellently approximated to a Gaussian distribution. Here, it may be understood that the probability distribution of the output of the user-side encoder neural network is a feedback for a pilot signal which the user side (user equipment) receives from the base station side, and the probability distribution of the output of the user-side encoder neural network is formed based on the pilot signal.

The Gaussian distribution may be uniquely determined when there is only two types information such as a mean and a variance (or a standard deviation) of the probability distribution. In this case, when the activation function of the last layer other than the quantization layer of the output of the user-side encoder neural network is constituted by a basis function of origin symmetry such as tan h, a mean of user-side encoder neural network output values may be approximated to 0. Accordingly, it may be assumed that the probability distribution of the output of the user-side encoder neural network may be excellently approximated to the zero-mean Gaussian distribution. In the case of the zero-mean Gaussian distribution, when only a variance value is given, the PDF may be accurately determined.

The user-side encoder neural network (user equipment) assumes that the probability distribution of the output of the user-side encoder neural network is excellently approximated to the zero-mean Gaussian distribution instead of transmitting all quantization rules obtained from the empirical PDF for the output of the user-side encoder neural network to empirically calculate and transmit only the variance of the probability distribution of the output of the user-side encoder neural network. In this case, transmission of the variance of the probability distribution of the output of the user-side encoder neural network may be performed from the user side (user equipment) to the base side (base station). Here, the variance in the user-side encoder neural network (user equipment) may be calculated according to a predetermined period. The period may be a batch size for training.

Furthermore, the empirically calculated variance which the user equipment transmits to the base station may also be exchanged in advance between the user equipment and the base station in a codebook form quantized based on a range which a value of the variance may have. Upon variance transmission of the use equipment, signaling may be performed based on a predefined codebook.

When the variance may be known by a base station-side decoder, the base station-side decoder may accurately determine the PDF through the variance. Accordingly, the quantization rule according to the PDF may be accurately restored by the base station-side decoder. In this case, the quantization rule restored by the decoder may coincide with a quantization rule obtained by a user-side encoder.

Additionally, the empirically calculated variance which the user equipment transmits to the base station may be transmitted when the probability distribution of the output of the user-side encoder neural network is changed. That is, when the probability distribution of the output of the user-side encoder neural network is changed, the user equipment may calculate the variance based on the changed probability distribution of the output of the user-side encoder neural network, and report the calculated variance to the base station. The pilot signal is related to forming of the probability distribution of the output of the user-side encoder neural network, but the user equipment is aware of the change in probability distribution of the output of the user-side encoder neural network, and as a result, the variance of the changed probability distribution may be calculated, so it may be understood that the pilot signal is also related to the calculation of the variance of the probability distribution. That is, the pilot signal may be related to the calculation of the quantization rule.

### Epoch-Specific Information for Straight-Through Estimator

In quantization-aware training, when input-output relationship characteristics of the quantization layer of an encoder neural network is expressed by one function, derivative coefficients are zero in most regions of the function, so gradients for the quantization layer as well as for the previous (input layer-side) layer also disappear by back-propagation as well as by a chain rule (or back-propagation). As a result, the back-propagation becomes difficult and the training becomes difficult. Here, for convenience of description, it is assumed that the function is a one-variable function, and as a result, an expression that “derivative coefficient (slope)” is 0 is used. The gradient may be a value for a plurality of weights and a bias connecting neurons of an adjacent layer to neurons present in respective layers.

For the back-propagation and training through the back-propagation in the quantization-aware training, a straight-through estimator (STE) may be used, which may replace the quantization layer with surrogate for the back-propagation. That is, in forward pass, the output of each neuron of the last layer of the encoder neural network is made to pass through a quantized activation, and the STE may be used only in the back-propagation. In this case, while the output is appropriately approximated to the quantized activation function, the output is differentiable in a specific region, and a function in which the value of the derivative coefficient is not zero may be used as the STE. That is, such a function is used as the STE, so the derivative coefficient is not zero any longer in a specific region, and as a result, the gradient may be non-trivial.

Functions such as a sigmoid-adjusted function, a (clipped) identity function, etc., may be used as the STE, and the performances of the training and the system may vary based on which type of function being selected as the STE.

As an example, a signum function shown in FIG. 12 may be approximated to and replaced with a function according to the following equation.

$$sgn ( u ) \approx 2 sigm ( {α}^{( i )} u ) - 1 = \frac{2}{1 + exp ( - {α}^{( i )} u )} - 1 \qquad [ Equation 4 ]$$

$${α}^{( i )} > {α}^{( i - 1 )}$$

Here, α^{(j)}>α⁽ⁱ⁻¹⁾ is an annealing factor in an i-th epoch, and this means a slope of the sigmoid function which increases as the training progresses. As the slope of the sigmoid function increases, the sigmoid function may be more appropriately approximated to the signum function. A scheme of increasing the slope of the sigmoid function as the training progresses may be called slope-annealing trick, and the performance of the STE may be enhanced through the slope-annealing trick. Information of which value varies every epoch, such as the annealing factor may be exchanged between the user side and the base station side every epoch (prior to training). The information of which value varies every epoch, such as the annealing factor may be called epoch-specific information. In this case, since the epoch-specific information may vary according to user-specific communication and training situations, the epoch-specific information may be transmitted from the user equipment side to the base station side.

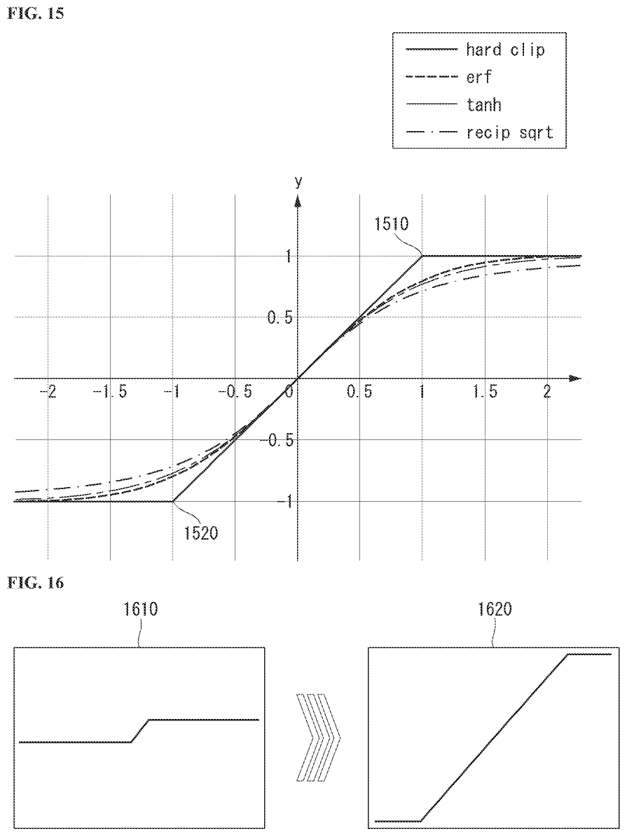

FIG. 15 is a view showing examples of a function which may be used as an STE and functions related thereto. More specifically, reference numerals 1510 and 1520 represent a clipped location of the clipped identity function. Referring to FIG. 15, it can be seen that the clipped location of the identity function is a point where x=1 and −1 on an x axis. The clipped location of the identity function may be changed as training progresses. In addition to the clipped identity function, referring to FIG. 15, functions such as erf, tan h, and recip sqrt are shown as functions related to the clipped identity function.

In addition to the slope-annealing factor, other information may be included in the epoch-specific information. More specifically, when the clipped identity function is used as the STE, information on the location at which the identity function is clipped may vary every epoch. As shown in FIG. 15, the clipped location of the clipped identity function in FIG. 15 is x=1 and −1, but when the variance for the probability distribution of the output of the user-side encoder neural network is small, the location at which the identity function is clipped may be close to a point where x=0. On the contrary, when the variance for the probability distribution of the output of the user-side encoder neural network is large, location at which the identity function is clipped may be far from the point where x=0. In this case, the location at which the identity is clipped may be far away up to an upper or lower bound (e.g., +1 or −1) of a region (e.g., [− [symbol] , [symbol] ) of the activation function (e.g., tan) just prior to the quantization layer.

[symbol]

FIG. 16 is a view showing an example of a clipped equality function change aspect as training progresses.

More specifically, in FIG. 16, when the variance of the probability distribution of the output of the user-side encoder neural network gradually increases as training progresses, the clipped location of the clipped identity function used as the STE may be changed from a form of reference numeral 1610 to a form of reference numeral 1620. Conversely, when the variance of the probability distribution of the output of the user-side encoder neural network gradually decreases as training progresses, the clipped location of the clipped identity function used as the STE may be changed from the form of reference numeral 1620 to the form of reference numeral 1610.

As described above, since the clipped location of the identity function may vary every epoch, the information on the clipped location of the identity function may be included in the epoch-specific information.

### Coarse Gradient

In the case of the back-propagation, in order to distinguish a gradient obtained by passing through the STE from a gradient obtained in a general case in which the surrogate in the back-propagation is not replaced with the STE, the gradient obtained by passing through the STE will be called coarse gradient. However, the term coarse gradient is just for convenience of description, and the coarse gradient may also be simply expressed as ‘gradient’. In order to an algorithm for training to operate, a coarse gradient obtained by an STE-modified chain rule may also be transmitted from the base station side to the user side every batch. An example of the algorithm for the training may include a scheme such as gradient descending. The term ‘gradient’ used above may be expressed as various forms such as gradient, etc., and also expressed in various schemes in an extent that the gradient is interpreted as the same thereas/similar thereto.

### Signaling Procedure—(Method 2)

In this method, a user equipment-base station signaling procedure for performing online learning proposed by the present disclosure is described. The signaling procedure proposed in this method may be divided into signaling before training the user equipment (user)-side encoder neural network and the base station-side decoder neural network, and signaling during training. Hereinafter, the signaling procedure will be described in detail in an order of the signaling before the training and the signaling during the training.

### Signaling Procedure Before Training

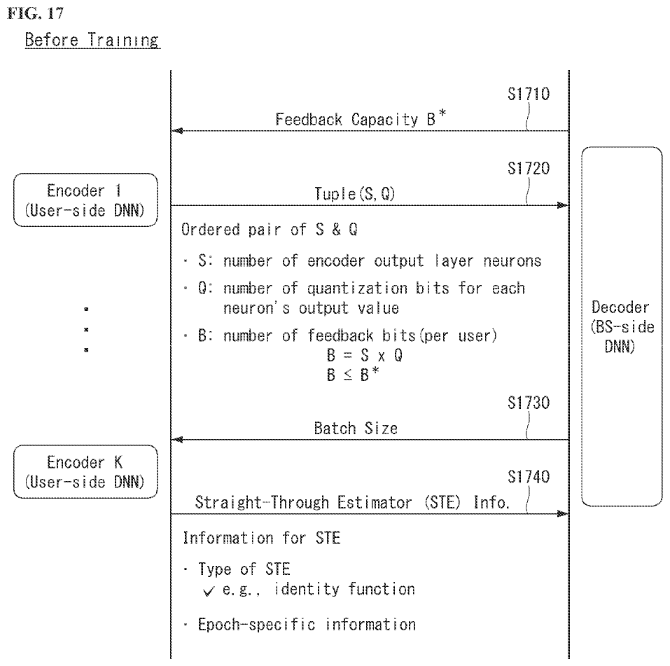

FIG. 17 is a flowchart showing an example of a UE-BS signaling procedure for performing online learning proposed by the present disclosure.

More specifically, FIG. 17 is a view which relates to an example of signaling before training of the user equipment-side encoder neural network and the base station-side decoder neural network.

Referring to FIG. 17, it can be seen that information required for the user equipment side and the base station side is exchanged prior to intrinsically performing the online learning. However, a signaling procedure shown in FIG. 17 is just an example, and the procedure shown in FIG. 17 should not particularly be performed as it is, and only some procedures may also be performed. Further, an order of the signaling shown in FIG. 17 may be changed, and some signal may also be omitted, of course.

Hereinafter, the respective procedures shown in FIG. 17 will be described in detail. An operation performed by the terminal side based on signaling performed between one user equipment side among multiple terminal sides shown in FIG. 17 and the base station side is described. Contents described below may also be applied in the same/similar manner from the viewpoint of the base station side.

S1710: First, the user equipment receives, from the base station, information on a feedback capacity B* used for feedback of the quantization rule information related to the quantization rule. In this case, the information on the feedback capacity B* may be calculated by considering a link (or channel) quality from each user. The feedback capacity may be defined as a maximum amount of information (the number of bits) which the user equipment may feed back to the user equipment during a specific period (e.g., coherence block). The information on the feedback capacity may also be called information on the maximum information amount, and variously expressed in a range of being interpreted in the same/similar manner thereas/thereto. In this case, the feedback capacity B* may be different for each user (user equipment), and there may be a tendency that a size of the feedback capacity B* further increases as a state of a link (or channel) becomes better
S1720: Thereafter, the user equipment transmits, to the base station, (i) the number of neurons constituting an output layer of an encoder neural network of the terminal and (ii) information on an order pair of the number of bits used for quantization of the output of the encoder neural network of the terminal.

More specifically, since the user equipment identify feedback capacities B* thereof based on the information on the maximum information amount received from the base station, the user equipment may select an order pair (S,Q) satisfying B=S×Q with respect to B GC satisfying B≤B*. Here, B means the number of feedback bits (per user (user equipment). In general, since more detailed information is fed back as a value of B becomes larger, the precoding performance may be enhanced as the value of B becomes larger. Further, in B=S×Q, S means the number of neurons constituting a last output layer of the user-side (user equipment) encoder neural network. When each user side (user equipment) has a plurality of different neural network candidates, the user equipment may select having an appropriate S value among the neural network candidates. That is, the neural network candidates may include the number of neurons constituting different output layers, and a neural network including the number neurons of a most appropriate number of output layers may be appropriately selected. When only a unique neural network is present at the user side (when there is only one neural network candidate), the value of S may be determined by the number of neurons included in (constituting) a last output layer of the unique neural GC network. Furthermore, in B=S×Q, Q means how many bits an output value output from each neuron is quantized into. That is, the output value output from the neuron may be quantized into a value of 2Q.

When (S,Q) is determined, the value of B=S×Q may be obtained based on the GC relationship such as 3, so each user side transmits the order pair (S,Q) to the base station. GC The base station may obtain the B value according to the relationship such as (S,Q) based on the B=S×Q received from the user equipment. In this case, B satisfies a relationship GC such as B≤B*. Even though the value of B is the same, a precoding performance (e.g., GC sum rate) may be different according to construction of the order pair (S,Q), the user GC equipment should appropriately select the order pair (S,Q).
S1730: Next, the user equipment receives, from the base station, information on a batch size which is a training unit in which training is performed. An appropriate batch size needs to be set for efficient training. Here, the batch size may be determined based on various factors in the base station. For example, the factors for determining the batch size may include base station-side computing power, the number of users, a link (or channel) quality from each user to the base station, and the information described in Method 1.
S1740: Last, the user equipment may transmit, to the base station, information on a straight-through estimator (STE). More specifically, each user equipment side may select an appropriate STE according to the probability distribution of the output of the user equipment-side encoder neural network. For example, the user equipment side may appropriately select the type of a function used as the STE, and multiple configurations for (the function as) the STE. The information on the STE may include information on the type of function described above.

Further, the information on the STE may include epoch-specific information as training progresses, and such information may be transmitted from the user equipment side to the base station side every epoch during a training progress. The information which may be included in the epoch-specific information is described in Method 1 above.

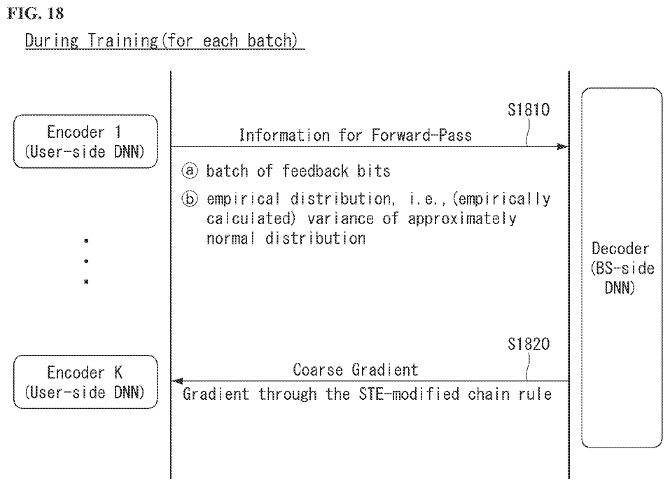

FIG. 18 is a flowchart showing an example of a UE-BS signaling procedure for performing online learning proposed by the present disclosure.

More specifically, FIG. 18 is a view which relates to an example of signaling performed every batch during training of the user equipment-side encoder neural network and the base station-side decoder neural network.

Referring to FIG. 18, it can be seen that information required for the user equipment side and the base station side is exchanged during intrinsic online learning. However, a signaling procedure shown in FIG. 18 is just an example, and the procedure shown in FIG. 18 should not particularly be performed as it is, and only some procedures may also be performed. Further, an order of the signaling shown in FIG. 18 may be changed, and some signal may also be omitted, of course.

Hereinafter, the respective procedures shown in FIG. 18 will be described in detail. An operation performed by the terminal side based on signaling performed between one user equipment side among multiple terminal sides shown in FIG. 18 and the base station side is described. Contents described below may also be applied in the same/similar manner from the viewpoint of the base station side.
S1810: For forward pass of training, the user equipment may transmit, to the base station, data corresponding to feedback bits generated in each user-side encoder neural network by the unit of a batch. In this case, a variance calculated by the unit of the batch (empirically calculated) may be transmitted from the user equipment to the base station. The purpose/meaning of the variance is described in Method 1 above. When the base station may not identify the probability distribution of the user equipment only by transmitting the variance, the user equipment may further transmit additional information in addition to the information on the variance. As an example of the case where the base station may not identify the probability distribution of the output of the encoder neural network of the user equipment, there may be a case where the output of the encoder neural network of the user equipment follows the Gaussian distribution, but a mean is not zero. Such a case, the base station may additionally require a mean value in order to identify the probability distribution of the output of the user equipment encoder neural network. Accordingly, the user equipment may further transmit, to the base station, information on the mean value in addition to a distribution value of the probability distribution of the output of the user equipment encoder neural network. The described contents may be simply understood as an operation in which the user equipment transmits the quantization rule information to the base station.

Additionally, before transmitting the variance of the output value of the encoder neural network of the user equipment, which is calculated by the unit of the batch (empirically calculated), the user equipment may judge whether to transmit the quantization rule information based on whether the probability distribution of the output of the encoder neural network being changed. More specifically, first, the user equipment may judge whether the empirical distribution of the output of the encoder neural network of the user equipment is changed. In this case, when it is judged that the empirical distribution of the output of the encoder neural network of the user equipment is changed, the user equipment may transmit the information on the variance.

Conversely, when it is judged that the empirical distribution of the output of the encoder neural network of the user equipment is not changed, the user equipment does not transmit the information on the variance. In this case, a pre-trained neural network parameter may be applied without update of the neural network parameter.

In this case, when the base station does not receive the information on the variance from the user equipment, a base station operation may be defined so that the base station recognizes that the empirical distribution of the output of the encoder neural network of the user equipment is not changed.
S1820: The user equipment may receive, from the base station, a coarse gradient corresponding to back-propagation of training every batch. The coarse gradient may be calculated by the base station based on the quantization rule information which the user equipment transmits to the base station. In this case, a pre-trained neural network parameter may be updated based on information on the coarse gradient received by the user equipment. A purpose and a meaning of the coarse gradient in this step S1820 are described in Method 1 above.

By Method 1 and Method 2 described above, the multiuser downlink precoding system may be optimized and operated. Further, on the multiuser downlink precoding system optimized by Method 1 and Method 2 described above, a channel state information (CSI) reporting operation of the user equipment may be performed. More specifically, on the multiuser downlink precoding system optimized by Method 1 and Method 2 described above, the user equipment may receive a reference signal for reporting the CSI from the base station. Thereafter, the user equipment may report, to the base station, the CSI calculated based on the reference signal. In this case, the CSI may include a precoding matrix indicator (PMI). Thereafter, the user equipment may receive downlink data from the base station, and the downlink data may be transmitted based on precoding by a precoding matrix indicated by the PMI. In summary, it may be understood that Method 1 and Method 2 described above are also merged with an existing CSI reporting operation of the user equipment, and performed.

### Effects

According to the method proposed by the present disclosure, since the user equipment, since the user equipment may not transmit information on all quantization rules, but transmit only the variance value of the probability distribution of the output of the user equipment neural network, there is an effect in which a processing time for calculating the quantization rule of the user equipment/base station is shortened, and signaling overhead for transmitting the quantization rule of the user equipment is reduced. Further, a plurality of mapping relationships between all possible cases of the probability distribution of the output of the user equipment encoder neural network and quantization rules therefor are defined, and all of the plurality of mapping relationships are not stored in the user equipment/base station, so there is an effect in which quantization rule determination and storage efficiency of the user equipment/base station may be enhanced. Further, there is an effect in which easiness of the online learning of the quantization-aware scheme is enhanced.

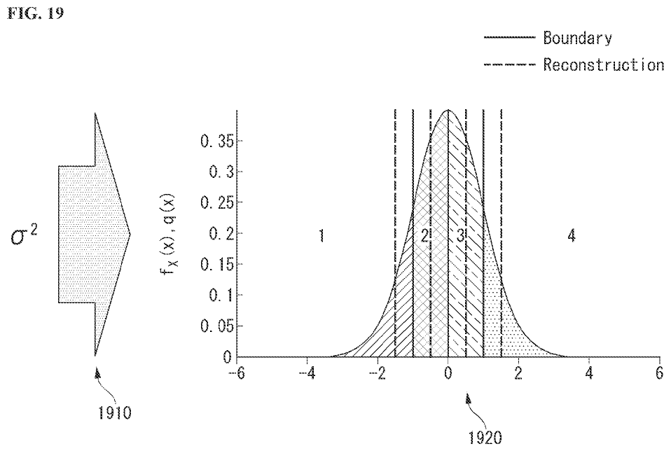

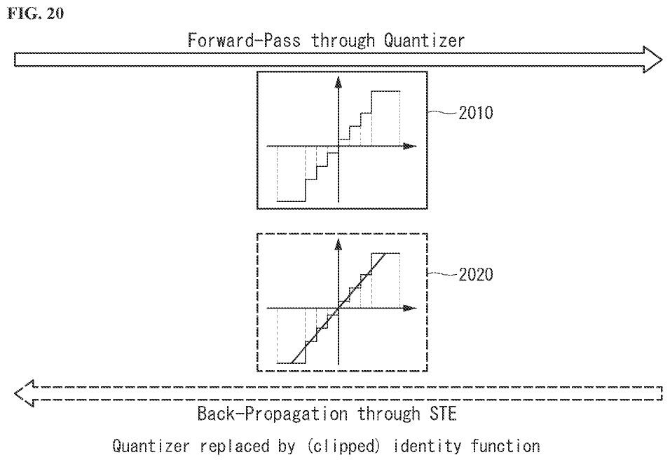

FIGS. 19 and 20 are views for describing a generation process of a technical effect according to a method proposed by the present disclosure.

Referring to FIG. 19, reference numeral 1910 may mean an operation in which a user equipment transmits, to a base station, a variance of a user equipment encoder neural network output distribution for reconstruction of the user equipment encoder neural network output distribution in the base station. Reference numeral 1920 may mean an operation of reconstructing the user equipment encoder neural network output distribution based on the variance of the received user equipment encoder neural network output distribution by the base station. There is an effect in which through the operations meant by reference numerals 1910 and 1920 in FIG. 19, the processing time for calculating the quantization rule of the user equipment/base station is shortened, and the signaling overhead of transmitting the quantization rule is reduced.

Referring to FIG. 20, reference numeral 2010 may mean that a forward operation for training through the quantizer of the user equipment is performed by the user equipment/base station. Reference numeral 2020 may mean that the user equipment/base station performs back-propagation through the STE. In this case, in the case of the back propagation, the quantizer may be replaced with a (clipped) identity function.

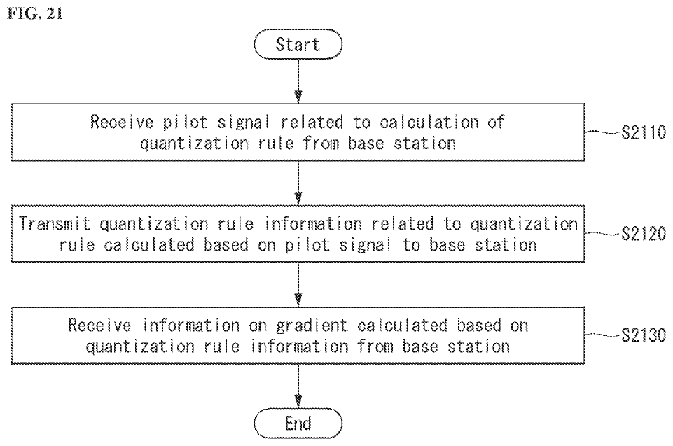

FIG. 21 is a flowchart showing an example of the method proposed by the present disclosure.

First, a user equipment receives, from a base station, a pilot signal related to calculation of a quantization rule (S2110).

Here, the quantization rule is determined based on an empirical distribution of an encoder neural network output of the user equipment.

Thereafter, the user equipment transmit, to the base station, quantization rule information related to the quantization rule calculated based on the pilot signal (S2120).

Next, the user equipment receives, from the base station, information on a gradient calculated based on the quantization rule information (S2130). Here, the quantization rule information includes information on the empirically calculated variance with respect to the empirical distribution of the encoder neural network output.

The embodiments of the present disclosure described above are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present disclosure or included as a new claim by subsequent amendment after the application is filed.

The embodiments of the present disclosure may be achieved by various means, for example, hardware, firmware, software, or a combination thereof. In a hardware configuration, the methods according to the embodiments of the present disclosure may be achieved by one or more Application Specific Integrated Circuits (ASICs). Digital Signal Processors (DSPs), Digital Signal Processing Devices (DSPDs), Programmable Logic Devices (PLDs). Field Programmable Gate Arrays (FPGAs), processors, controllers, microcontrollers, microprocessors, etc.

In a firmware or software configuration, the embodiments of the present disclosure may be implemented in the form of a module, a procedure, a function, etc. For example, software code may be stored in a memory unit and executed by a processor. The memories may be located at the interior or exterior of the processors and may transmit data to and receive data from the processors via various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The present disclosure is described based on an example applied to the 3GPP LTE/LTE-A system and the 5G system, but it is possible to apply the present disclosure to various wireless communication systems in addition to the 3GPP LTE/LTE-A system and the 5G system.

1. A method for reporting, by a terminal, channel state information (CSI) in a wireless communication system, the method comprising:
receiving, from a base station, a pilot signal related to calculation of a quantization rule,
wherein the quantization rule is determined based on an empirical distribution of an encoder neural network output of the terminal;
transmitting, to the base station, quantization rule information related to the quantization rule calculated based on the pilot signal; and
receiving, from the base station, information on a gradient calculated based on the quantization rule information,
wherein the quantization rule information includes information on an empirically calculated variance with respect to the empirical distribution of the encoder neural network output.

2. The method of claim 1, further comprising:
receiving, from the base station, information on a maximum information amount used for feedback of the quantization rule information related to the quantization rule.

3. The method of claim 2, further comprising:
transmitting, to the base station, (i) the number of neurons constituting an output layer of an encoder neural network of the terminal and (ii) information on an order pair of the number of bits used for quantization of the output of the encoder neural network of the terminal.

4. The method of claim 1, wherein the quantization rule information is calculated according to a period determined based on a batch size for training a neural network.

5. The method of claim 1, wherein the encoder neural network of the terminal includes (i) a quantization layer for quantization of an output value of the encoder neural network and (ii) a straight-through estimator (STE) function which is a differentiable function used during back-propagation.

6. The method of claim 1, wherein the information on the variance is transmitted based on a codebook configured by quantizing a range of a value of the variance.

7. The method of claim 1, wherein values which the output of the encoder neural network of the terminal may have follow a Gaussian distribution.

8. The method of claim 7, wherein when a mean value of the values which the output of the encoder neural network of the terminal may have is not 0, the quantization rule information further includes information on the mean value of the values which the output of the encoder neural network of the terminal may have.

9. The method of claim 1, wherein the transmitting of the quantization rule information further includes
determining whether the empirical distribution of the output of the encoder neural network of the terminal is changed.

10. The method of claim 9, wherein when it is determined that the empirical distribution of the output of the encoder neural network of the terminal is changed, the information on the variance is transmitted.

11. The method of claim 10, further comprising:
receiving, from the base station, the information on the gradient calculated based on the quantization rule information.

12. The method of claim 11, wherein a pre-trained neural network parameter is updated based on the information on the gradient calculated based on the quantization rule information.

13. The method of claim 9, wherein when it is determined that the empirical distribution of the output of the encoder neural network of the terminal is not changed, the information on the variance is not transmitted, and the pre-trained neural network parameter is applied.

14. The method of claim 1, further comprising:
reporting, to the base station, the CSI calculated based on the pilot signal,
wherein the CSI includes a precoding matrix indicator (PMI).

15. The method of claim 14, further comprising:
receiving downlink data from the base station,
wherein the downlink data is transmitted based on precoding by a precoding matrix indicated by the PMI.

16. A terminal for reporting channel state information (CSI) in a wireless communication system, the terminal comprising:
a transmitter for transmitting a radio signal;
a receiver for receiving the radio signal;
at least one processor; and
at least one computer memory operably connectable to the at least one processor, and storing instructions of performing operations when executed by the at least one processor,
wherein the operations include
receiving, from a base station, a pilot signal related to calculation of a quantization rule,
wherein the quantization rule is determined based on an empirical distribution of an encoder neural network output of the terminal,
transmitting, to the base station, quantization rule information related to the quantization rule calculated based on the pilot signal, and
receiving, from the base station, information on a gradient calculated based on the quantization rule information, and
wherein the quantization rule information includes information on an empirically calculated variance with respect to the empirical distribution of the encoder neural network output.

17. A method for being reported, by a base station, channel state information (CSI) in a wireless communication system, the method comprising:
transmitting, to a terminal, a pilot signal related to calculation of a quantization rule,
wherein the quantization rule is determined based on an empirical distribution of an encoder neural network output of the terminal;
receiving, from the terminal, quantization rule information related to the quantization rule calculated based on the pilot signal; and
transmitting, to the terminal, information on a gradient calculated based on the quantization rule information,
wherein the quantization rule information includes information on an empirically calculated variance with respect to the empirical distribution of the encoder neural network output.

18-20. (canceled)
